(19) United States
(12) Patent Application Publication
(10) Pub. No.: US 2019/0202493 A1
(43) Pub. Date: Jul. 4, 2019

(54) VEHICLE CONTROL APPARATUS

(71) Applicant: HONDA MOTOR CO., LTD., Tokyo (JP)

(72) Inventor: Hiroyuki KAWAGOE, Wako-shi (JP)

(21) Appl. No.: 16/190,778

(22) Filed: Nov. 14, 2018

(30) Foreign Application Priority Data
Dec. 28, 2017 (JP) 2017-254278

(51) Int. Cl. B62D 5/04; G05D 1/00

(52) U.S. Cl. CPC B62D 5/046; G05D 2201/0213; B62D 5/0481; G05D 1/0061

(57) ABSTRACT

A vehicle control apparatus is capable of switching driving control between automated driving and manual driving. The apparatus includes a detection unit configured to detect an intervention operation by a driver during traveling by the automated driving, and a control unit configured to switch steering control of an electric power steering from automated steering to manual steering when the intervention operation is detected by the detection unit. The control unit executes suppression control to suppress an occurrence of abrupt steering when the detection unit detects the intervention operation during a turn of a vehicle.

### BACKGROUND OF THE INVENTION

### Field of the Invention

The present invention relates to a vehicle control apparatus.

### Description of the Related Art

Automated driving of a vehicle contributes to reduction of a burden on a driver. However, in some cases, traveling by automated driving is difficult, or manual driving is more suitable. Hence, a control apparatus capable of switching between automated driving and manual driving has been proposed. Japanese Patent Laid-Open No. 2014-106854 proposes a technique of making a notification, during automated driving, to urge a driver to cancel the automated driving in a case in which a predetermined condition is not satisfied. In addition to the technique of promoting switching from automated driving to manual driving from the system side, a technique of switching to manual driving when a driver performs an intervention operation during automated driving is also known.

When switching from automated driving to manual driving by the intervention operation during a turn of a vehicle, if the steering output of the electric power steering output during the automated driving instantaneously disappears, the driver who performs manual steering may be given a sense of incongruity.

### SUMMARY OF THE INVENTION

It is an object of the present invention to provide a vehicle control apparatus for reducing a sense of incongruity for a driver when switching from automated driving to manual driving during a turn of a vehicle.

According to an aspect of the present invention, there is provided a vehicle control apparatus capable of switching driving control between automated driving and manual driving, comprising: a detection unit configured to detect an intervention operation by a driver during traveling by the automated driving; and a control unit configured to switch steering control of an electric power steering from automated steering to manual steering when the intervention operation is detected by the detection unit, wherein the control unit executes suppression control to suppress an occurrence of abrupt steering when the detection unit detects the intervention operation during a turn of a vehicle.

Further features of the present invention will become apparent from the following description of exemplary embodiments (with reference to the attached drawings).

### BRIEF DESCRIPTION OF THE DRAWINGS

FIG. 1 is a block diagram of a vehicle control apparatus according to an embodiment;

FIGS. 2A and 2B are flowcharts showing an example of processing executed by the vehicle control apparatus shown in FIG. 1;

FIG. 3A is a view showing an example of a change in the motor output of an electric power steering at the time of an operation intervention;

FIG. 3B is a view showing an example of vehicle behavior at the time of an operation intervention during a turn;

FIGS. 4A and 4B are flowcharts showing an example of processing executed by the vehicle control apparatus shown in FIG. 1;

FIG. 5A is a flowchart showing an example of processing executed by the vehicle control apparatus shown in FIG. 1;

FIGS. 5B and 5C are explanatory views of a control amount; and

FIG. 6 is a flowchart showing an example of processing executed by the vehicle control apparatus shown in FIG. 1.

### DESCRIPTION OF THE EMBODIMENTS

### First Embodiment

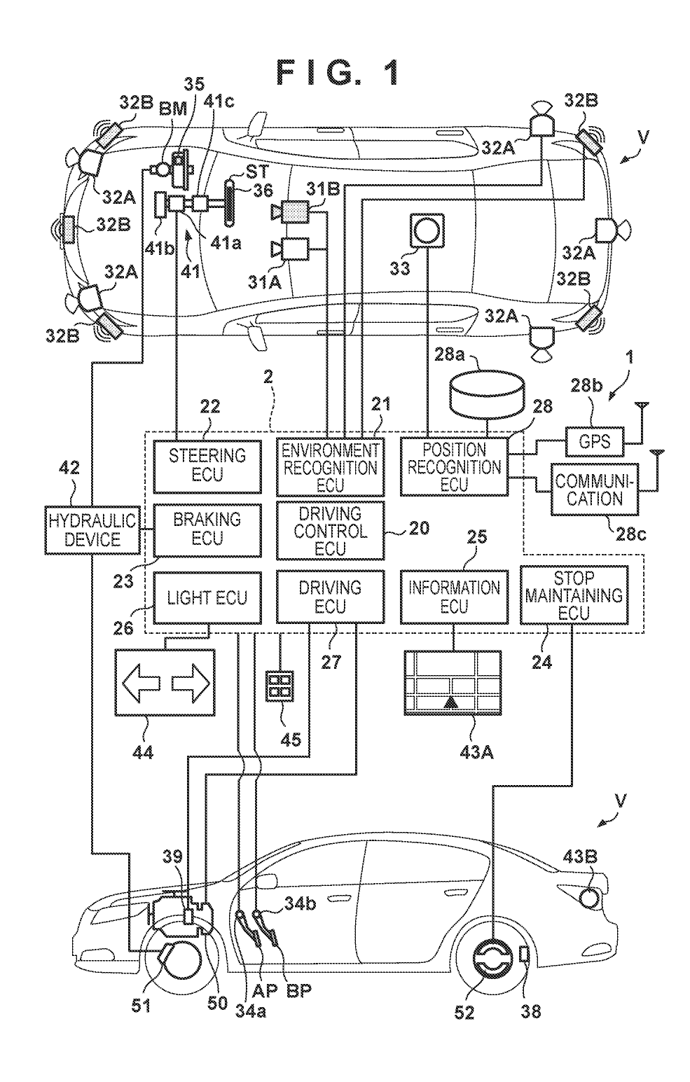

FIG. 1 is a block diagram of a vehicle control apparatus 1 according to an embodiment of the present invention. The control apparatus 1 controls a vehicle V. FIG. 1 shows the schematic arrangement of the vehicle V in a plan view and a side view. As an example, the vehicle V is a sedan-type four-wheeled passenger car.

The vehicle V according to this embodiment is, for example, a parallel-type hybrid vehicle. In this case, a power plant 50 that outputs a driving force to rotate the driving wheels of the vehicle V can be formed by an internal combustion engine, a motor, and an automatic transmission. The motor can be used as a driving source configured to accelerate the vehicle V and can also be used as a power generator at the time of deceleration or the like (regenerative braking).

<Control Apparatus 1>

The arrangement of the control apparatus 1 will be described with reference to FIG. 1. The control apparatus 1 includes an ECU group (control unit group) 2. The ECU group 2 includes a plurality of ECUs 20 to 28 configured to be communicable with each other. Each ECU includes a processor represented by a CPU, a storage device such as a semiconductor memory, an interface to an external device, and the like. The storage device stores programs to be executed by the processor, data to be used by the processor for processing, and the like. Each ECU may include a plurality of processors, storage devices, and interfaces. Note that the number of ECUs and the provided functions can appropriately be designed, and they can be subdivided or integrated as compared to this embodiment. Note that in FIG. 1, the names of representative functions of the ECUs 20 to 28 are added. For example, the ECU 20 is described as “driving control ECU”.

The ECU 20 executes control associated with traveling support including automated driving of the vehicle V. In automated driving, driving (acceleration or the like of the vehicle V by the power plant 50), steering, and braking of the vehicle V are automatically performed without requiring an operation of the driver. Additionally, in manual driving, the ECU 20 can execute, for example, traveling support control such as collision reduction brake or lane departure suppression. In the collision reduction brake, when the possibility of collision against a front obstacle rises, actuation of a brake device 51 is instructed to support collision avoidance. In the lane departure suppression, when the possibility of departure of the vehicle V from the traveling lane rises, actuation of an electric power steering device 41 is instructed to support lane departure suppression.

The ECU 21 is an environment recognition unit configured to recognize the traveling environment of the vehicle V based on the detection results of detection units 31A, 31B, 32A, and 32B configured to detect the ambient situation of the vehicle V In this embodiment, the detection units 31A and 31B are cameras (to be sometimes referred to as the cameras 31A and 31B hereinafter) that capture the front side of the vehicle V and are provided on the roof front of the vehicle V. When images captured by the cameras 31A and 31B are analyzed, the contour of a target or a division line (a white line or the like) of a lane on a road can be extracted.

In this embodiment, the detection unit 32A is a lidar (Light Detection and Ranging) (to be sometimes referred to as the lidar 32A hereinafter), and detects a target on the periphery of the vehicle V or measures the distance to a target. In this embodiment, five lidars 32A are provided; one at each corner of the front portion of the vehicle V, one at the center of the rear portion, and one on each side of the rear portion. The detection unit 32B is a millimeter wave radar (to be sometimes referred to as the radar 32B hereinafter), and detects a target on the periphery of the vehicle V or measures the distance to a target. In this embodiment, five radars 32B are provided; one at the center of the front portion of the vehicle V, one at each corner of the front portion, and one at each corner of the rear portion.

The ECU 22 is a steering control unit configured to control the electric power steering device 41. The electric power steering device 41 includes a mechanism that steers the front wheels in accordance with the driving operation (steering operation) of the driver on a steering wheel ST. The electric power steering device 41 includes a driving unit 41a including a motor that generates a driving force (to be sometimes referred to as a steering assist torque) to assist the steering operation or automatically steer the front wheels, a steering angle sensor 41b, a torque sensor 41c that detects a steering torque (to be referred to as a steering burden torque which is discriminated from the steering assist torque) borne by the driver, and the like. The ECU 22 can also acquire the detection result of a sensor 36 configured to detect whether the driver is gripping the steering wheel ST, and can monitor the grip state of the driver.

The ECU 23 is a braking control unit configured to control a hydraulic device 42. The braking operation of the driver on a brake pedal BP is converted into a liquid pressure by a brake master cylinder BM and transmitted to the hydraulic device 42. The hydraulic device 42 is an actuator capable of controlling the liquid pressure of hydraulic oil supplied to the brake device (for example, a disc brake device) 51 provided on each of the four wheels based on the liquid pressure transmitted from the brake master cylinder BM, and the ECU 23 drives and controls a solenoid valve and the like provided in the hydraulic device 42. At the time of braking, the ECU 23 can light a brake lamp 43B. This can raise the attention of a following vehicle to the vehicle V.

The ECU 23 and the hydraulic device 42 can form an electric servo brake. The ECU 23 can control, for example, distribution of a braking force by the four brake devices 51 and a braking force by regenerative braking of the motor provided in the power plant 50. The ECU 23 can also implement an ABS function, traction control, and the posture control function of the vehicle V based on the detection results of a wheel speed sensor 38 provided on each of the four wheels, a yaw rate sensor (not shown), and a pressure sensor 35 that detects the pressure in the brake master cylinder BM.

The ECU 24 is a stop maintaining control unit configured to control an electric parking brake device (for example, a drum brake) 52 provided on the rear wheels. The electric parking brake device 52 includes a mechanism that locks the rear wheels. The ECU 24 can control lock of the rear wheels and lock cancel by the electric parking brake device 52.

The ECU 25 is an internal notification control unit configured to control an information output device 43A that notifies information in the vehicle. The information output device 43A includes, for example, a head up display or a display device provided on an instrument panel or a sound output device. The information output device 43A may also include a vibration device. The ECU 25 causes the information output device 43A to output, for example, various kinds of information such as a vehicle speed and an outside temperature, information such as a route guide, and information about the state of the vehicle V.

The ECU 26 is an external notification control unit configured to control an information output device 44 that notifies information outside the vehicle. In this embodiment, the information output device 44 is a direction indicator (hazard lamp). The ECU 26 can notify the advancing direction of the vehicle V to the outside by controlling blinking of the information output device 44 serving as a direction indicator and can also raise the attention of the outside to the vehicle V by controlling blinking of the information output device 44 serving as a hazard lamp.

The ECU 27 is a driving control unit configured to control the power plant 50. In this embodiment, one ECU 27 is assigned to the power plant 50. However, one ECU may be assigned to each of the internal combustion engine, the motor, and the automatic transmission. The ECU 27, for example, controls the output of the internal combustion engine or the motor or switches the gear range of the automatic transmission in correspondence with the driving operation of the driver or the vehicle speed detected by an operation detection sensor 34a provided on an accelerator pedal AP or an operation detection sensor 34b provided on the brake pedal BP. Note that the automatic transmission is provided with a rotation speed sensor 39 configured to detect the rotation speed of the output shaft of the automatic transmission as a sensor that detects the traveling state of the vehicle V. The vehicle speed of the vehicle V can be calculated from the detection result of the rotation speed sensor 39.

The ECU 28 is a position recognition unit configured to recognize the current position or track of the vehicle V. The ECU 28 performs control of a gyro sensor 33, a GPS sensor 28b, and a communication device 28c and information processing of a detection result or a communication result. The gyro sensor 33 detects the rotary motion of the vehicle V. The track of the vehicle V can be determined based on the detection result of the gyro sensor 33 and the like. The GPS sensor 28b detects the current position of the vehicle V. The communication device 28c performs wireless communication with a server that provides map information and traffic information and acquires these pieces of information. A database 28a can store accurate map information. The ECU 28 can more accurately specify the position of the vehicle V on a lane based on the map information and the like.

An input device 45 is arranged inside the vehicle so as to be operable by the driver and receives instruction or information input from the driver.

<Example of Control>

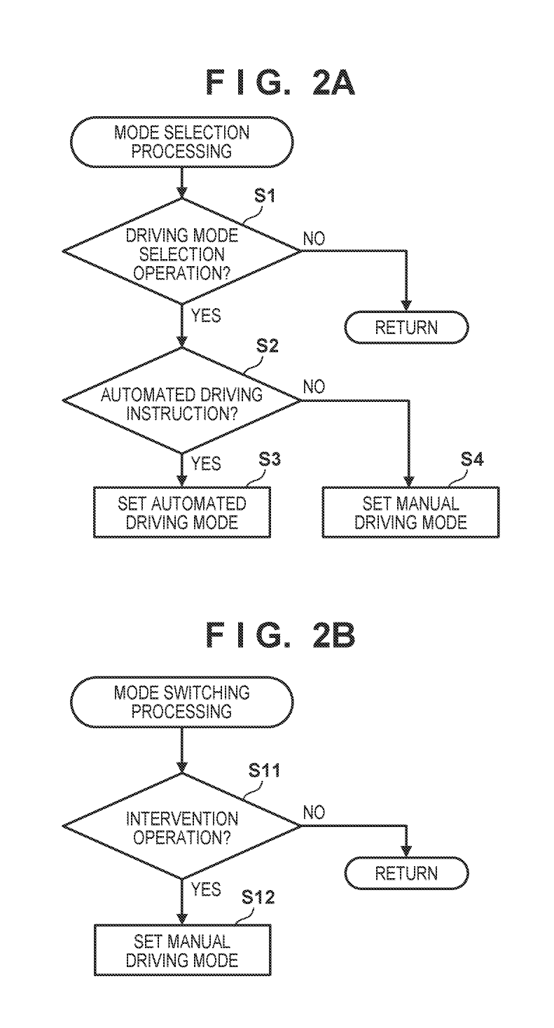

An example of control of the control apparatus 1 will be described. FIG. 2A is a flowchart showing mode selection processing executed by the ECU 20.

In step S1, it is determined whether a mode selection operation is performed by the driver. The driver can instruct switching between an automated driving mode and a manual driving mode by, for example, an operation on the input device 45. If a selection operation is performed, the process advances to step S2. Otherwise, the processing ends.

In step S2, it is determined whether the selection operation instructs automated driving. If the selection operation instructs automated driving, the process advances to step S3. If the selection operation instructs manual driving, the process advances to step S4. In step S3, the automated driving mode is set, and automated driving control is started. In step S4, the manual driving mode is set, and manual driving control is started. Current settings concerning the mode of driving control are notified from the ECU 20 to the ECUs 21 to 28 and recognized.

In the manual driving control, driving, steering, and braking of the vehicle V are performed in accordance with the driving operation of the driver, and the ECU 20 executes traveling support control as needed. In the automated driving control, the ECU 20 outputs a control instruction to the ECUs 22, 23, and 27 to control the steering, braking, and driving of the vehicle V, thereby automatically making the vehicle V travel without the driving operation of the driver. The ECU 20 sets the traveling route of the vehicle V and causes the vehicle V to travel along the set traveling route by referring to the position recognition result of the ECU 28 or a target recognition result. A target is recognized based on the detection results of the detection units 31A, 31B, 32A, and 32B.

When the driver performs a predetermined intervention operation during the automated driving mode, the mode of driving control is switched from the automated driving mode to the manual driving mode. FIG. 2B is a flowchart showing an example of mode switching processing at the time of the intervention operation executed by the ECU 20 during the automated driving mode.

In step S11, it is determined whether the intervention operation is performed. The intervention operation is, for example, the braking operation of the driver on the brake pedal BP. The braking operation can be recognized from the detection result of the operation detection sensor 34b or the pressure sensor 35. For the intervention operation, not only the simple presence/absence of the operation but also the degree may be taken into consideration. For example, in a case of the braking operation, instead of checking the simple presence/absence of the braking operation, whether the braking operation is an abrupt braking operation or not may be used as the criterion. In this case, the determination can be done by determining whether the braking effort or operation amount represented by the detection result of the operation detection sensor 34b or the pressure sensor 35 is equal to or larger than a predetermined threshold.

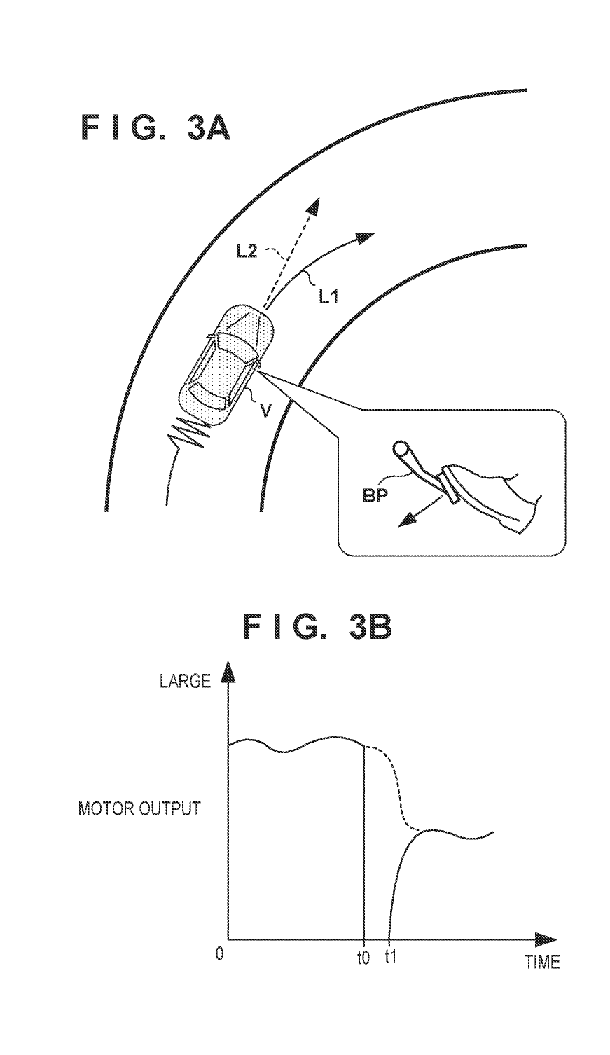

Switching the mode of driving control by such an operation intervention is advantageous from the viewpoint of reflecting the driver's intention on the control. However, depending on the traveling situation of the vehicle V, if the mode is instantaneously switched from the automated driving mode to the manual driving mode, the driver may be given a sense of incongruity. FIG. 3A is a view showing an example. FIG. 3A assumes a case in which the driver performs the braking operation on the brake pedal BP when the vehicle V is turning a curve to right by automated driving, and the mode of driving control is switched from the automated driving mode (automated steering) to the manual driving mode (manual steering) by the intervention operation.

During the turn of the vehicle V, a self-aligning torque (to be sometimes referred to as a SAT hereinafter) acts. If the control is performed such that the steering output (steering assist torque) of the electric power steering 41 output during the automated driving instantaneously disappears when the mode of driving control is switched, there may be an influence on the behavior of the vehicle V depending on the timing of the steering operation of the driver on the steering wheel ST. For example, if the steering operation of the driver is performed at an appropriate timing, the vehicle can directly turn along the curve, as indicated by a line L1.

However, if the timing of the steering operation delays, the vehicle V may have an understeer tendency, as indicated by a broken line L2, and the driver may be given a sense of incongruity. FIG. 3B shows an example of a change in the steering output (the motor output of the driving unit 41a) of the electric power steering 41 in a case in which the timing of the steering operation delays. As indicated by a solid line, at time t0, the mode is switched from the automated driving mode to the manual driving mode by an operation intervention, and the motor output changes to 0. At time t1 delayed from time t0, the steering operation of the driver is detected, and the motor output rises as the steering assist torque, as indicated by a solid line. According to the motor output change indicated by the solid line, since the motor output is 0 in the section from time t0 to time t1, it is sometimes impossible to cope with the SAT. In this embodiment, control (to be referred to as suppression control) to obtain a motor output capable of coping with the SAT, as indicated by a broken line in FIG. 3B, is executed without instantaneously reducing the motor output to 0 at time t0. The suppression control is control to suppress an occurrence of abrupt steering. A detailed example will be described below.

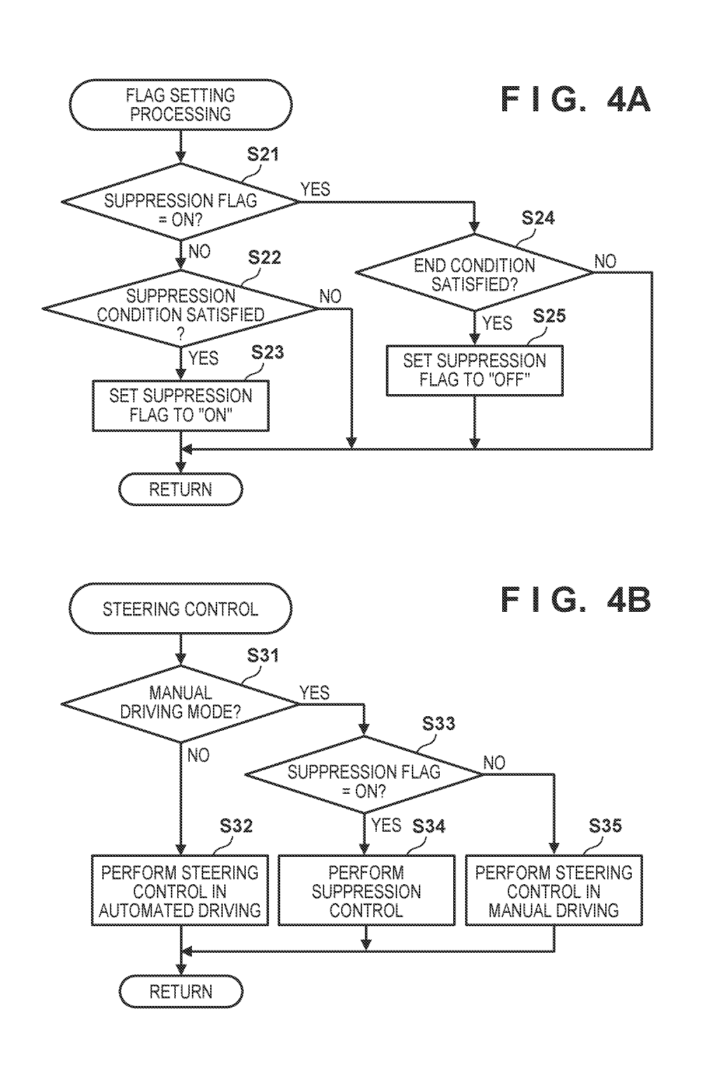

FIG. 4A shows processing executed by the ECU 22, which is processing concerning setting of a suppression flag to determine whether to perform suppression control. ON/OFF of the suppression flag can be set using the storage area of the storage device included in the ECU 22.

In step S21, it is determined whether the suppression flag is ON. If the suppression flag is OFF, the process advances to step S22. If the suppression flag is ON, the process advances to step S24. In step S22, it is determined whether a suppression condition is satisfied. The suppression condition is an execution permission condition of suppression control. The suppression condition is, for example, switching from the automated driving mode to the manual driving mode caused by the intervention operation performed during a turn of the vehicle V around a curve. Upon determining that the suppression condition is satisfied, the process advances to step S23. Upon determining that the suppression condition is not satisfied, the processing ends. In step S23, the suppression flag is set to “ON”.

In step S24, it is determined whether a suppression end condition is satisfied. The suppression end condition is an execution permission end condition of suppression control. The suppression end condition is, for example, an end of a turn of the vehicle V around a curve (for example, the steering angle is equal to or less than a threshold). Upon determining that the suppression end condition is satisfied, the process advances to step S25. Upon determining that the suppression end condition is not satisfied, the processing ends. In step S25, the suppression flag is set to “OFF”.

FIG. 4B shows processing executed by the ECU 22, which is processing concerning control of the electric power steering 41. In step S31, it is determined whether the current mode of driving control is the manual driving mode. Upon determining that the current mode of driving control is the manual driving mode, the process advances to step S33. Upon determining that the current mode of driving control is not the manual driving mode (upon determining that the current mode of driving control is the automated driving mode), the process advances to step S32.

In step S32, steering control in the automated driving is executed. Here, the electric power steering 41 is controlled based on the action plan of the vehicle V set by the ECU 20. More specifically, the control amount of the electric power steering 41 is calculated and output based on the characteristics (a straight line, the curvature of a curve, and a gradient) of the road of traveling specified from map information and the current position of the vehicle V, the vehicle speed, the posture of the vehicle V, and the current steering angle. Note that the control amount of control in each of steps S32, S34, and S35 to be described later is, for example, the control amount of the steering assist torque (the current control amount of the driving unit 41a).

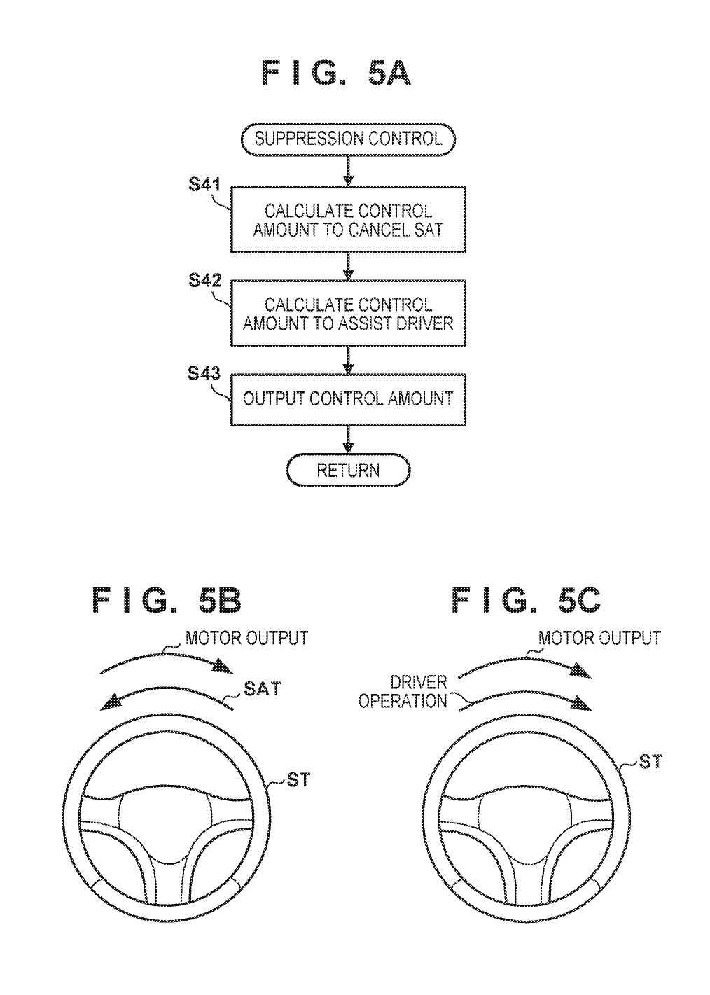

In step S33, it is determined whether the suppression flag is ON. If the suppression flag is ON, the process advances to step S34. If the suppression flag is OFF, the process advances to step S35. In step S34, suppression control is executed. That is, control of the electric power steering 41 in a state in which the mode is switched to the manual driving mode by an operation intervention during a turn of the vehicle V by the automated driving mode is executed. FIG. 5A is a flowchart showing an example of processing of suppression control. In the suppression control, the steering operation of the driver is assisted while suppressing an occurrence of abrupt steering.

In step S41, a control amount to cancel a SAT is calculated. This control amount is calculated based on, for example, a steering speed calculated from the detection result of the steering angle sensor 41b, and is also calculated such that a steering assist torque is generated in a direction opposite to the steering direction calculated from the detection result of the steering angle sensor 41b. FIG. 5B is a schematic view. In FIG. 5B, the steering wheel ST rotates counterclockwise by the SAT. In this case, the control amount in step S41 is calculated such that a steering assist torque to rotate the steering wheel ST clockwise is generated. The higher the steering speed is, the larger the steering assist torque can be made. The lower the steering speed is, the smaller the steering assist torque can be made. This can suppress an abrupt decrease of the steering assist torque of the electric power steering 41 and reduce the sense of incongruity for the driver even in a situation in which a strong SAT is generated at the time of switching from automated driving to manual driving by an intervention operation during a turn of the vehicle V.

In step S42, a control amount to assist the steering operation of the driver is calculated. This control amount is calculated based on, for example, a steering burden torque calculated from the detection result of the torque sensor 41c and a steering burden torque speed (the differential value of the steering burden torque), and is also calculated such that a steering assist torque is generated in a direction in which the steering burden torque decreases. FIG. 5C is a schematic view. In FIG. 5C, the steering wheel ST rotates clockwise by the operation of the driver. In this case, the control amount in step S42 is calculated basically such that a steering assist torque to rotate the steering wheel ST clockwise is generated. Note that the steering speed is used to calculate the control amount in step S41 and is therefore not used to calculate the control amount in step S42.

In step S43, a control amount obtained by adding the control amounts calculated in steps S41 and S42 is output. With this processing, it is possible to assist manual steering by the driver while avoiding abrupt steering by the SAT.

Referring back to FIG. 4B, in step S35, steering control in the manual driving is executed. The control here is the same as the control to assist the steering operation of the driver described concerning step S42 of FIG. 5A. However, the control amount can be calculated based on the steering speed calculated from the detection result of the steering angle sensor 41b in addition to the steering burden torque and the steering burden torque speed, and smoother steering assist can be performed. In this case, the control amount is calculated such that a steering assist torque is generated in the same direction as the steering direction calculated from the detection result of the steering angle sensor 41b, unlike step S41.

### Second Embodiment

In the first embodiment, the processing of calculating the control amount is changed between suppression control (step S34) and steering control (step S35) in manual driving. However, the same processing may be performed, and the control characteristic may be changed. More specifically, in suppression control, the control characteristic may be changed to enhance the effect of a steering damper. This makes it possible to suppress an occurrence of abrupt steering when an operation intervention is performed during a turn while using the same processing in common to calculate the control amount.

As a method of changing the control characteristic to enhance the effect of the steering damper, a control gain associated with damping is changed. For example, when a motor current is set as a control amount, a base current is calculated by multiplying a steering burden torque, a steering angle, a steering speed, and a vehicle speed by the control gain. In addition, a damping current is calculated by multiplying the steering speed by the control gain. A motor current is set by adding these currents. The control gain used to calculate the damping current is configured to be changeable, thereby suppressing abrupt steering when a suppression flag is ON.

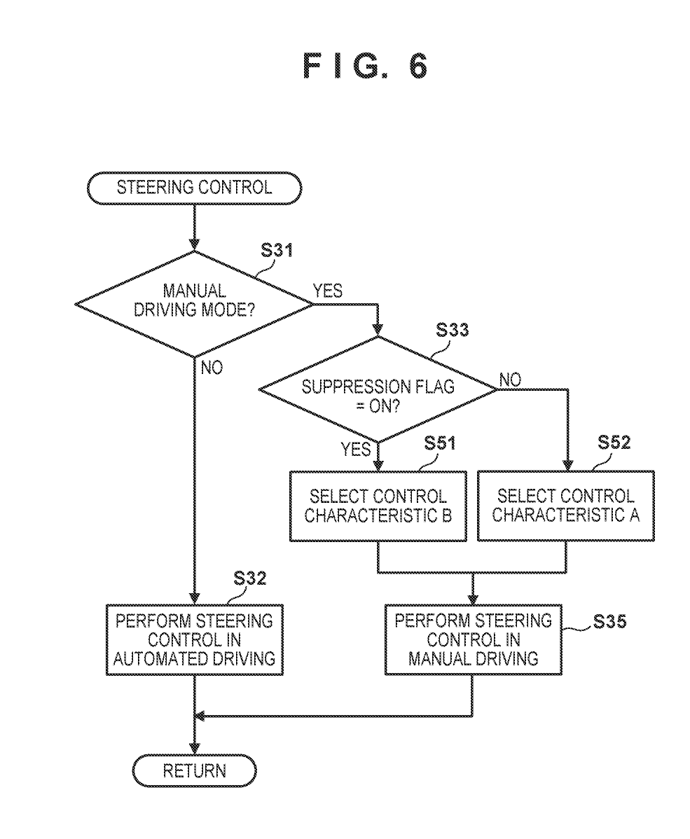

FIG. 6 is a flowchart showing an example of processing according to this embodiment, and shows an example of steering control processing executed by an ECU 22 in place of the steering control processing shown in FIG. 4B. The same step numbers as in the processing shown in FIG. 4B denote the steps of the same processing contents in the processing example shown in FIG. 6, and a description thereof will be omitted. Different processes will be described.

In this embodiment, if the suppression flag is ON in step S33, the process advances to step S51. If the suppression flag is OFF, the process advances to step S52. In step S51, a control characteristic B is selected. In step S52, a control characteristic A is selected. The control characteristic A is a control characteristic in the normal state. The control characteristic B is a control characteristic in a state in which the mode is switched to the manual driving mode by an operation intervention during a turn of a vehicle V by the automated driving mode. In step S35, steering control in the manual driving is performed based on the control characteristic selected in step S51 or S52.

The control characteristic B is a characteristic capable of obtaining an enhanced effect of the steering damper as compared to the control characteristic A. This can suppress abrupt steering. When the control characteristic B in step S51 is selected, and the steering control in step S35 is performed, the same steering control as the suppression control according to the first embodiment can be performed.

### OTHER EMBODIMENTS

In the above-described embodiments, as the suppression condition shown in step S22 of FIG. 4A, switching from the automated driving mode to the manual driving mode caused by the intervention operation performed during a turn of the vehicle V around a curve has been exemplified. However, if the degree of the turn is small, the SAT is small, and the necessity of suppression control is low. Hence, the SAT when switching from the automated driving mode to the manual driving mode may be estimated, and a condition that the estimated SAT is equal to or more than a threshold may be included in the suppression condition. As the estimated value of the SAT, the steering assist torque of the electric power steering 41 immediately before switching from the automated driving mode to the manual driving mode may be used. When the steering assist torque is a predetermined value or more, the suppression flag may be set to “ON”. Alternatively, the estimated value of the SAT may be a value calculated using at least one of the steering angle, horizontal G, and vehicle speed as a parameter.

In the above-described embodiments, as the execution permission end condition shown in step S24 of FIG. 4A, an end of a turn has been exemplified. However, the condition may be confirmation of the driver's steering intention. For example, when the detection result (steering burden torque) of the torque sensor 41c is equal to or more than a threshold, or the steering speed is equal to or more than a threshold in a direction opposite to the SAT generation direction, it may be determined that a steering intention exists.

In addition, as the contents of suppression control, the control amount may be set by a value (=T1+T2) obtained by adding a steering assist torque T1 based on the steering assist torque of the electric power steering 41 immediately before switching from the automated driving mode to the manual driving mode and a steering assist torque T2 based on the steering of the driver. The steering assist torque T1 may maintain the steering assist torque of the electric power steering 41 immediately before the switching for a predetermined time or gradually lowers the steering assist torque during a predetermined time. The steering assist torque T2 may be a control amount calculated by the same method as the processing of step S35 in FIG. 4B or the processing of step S42 in FIG. 5A.

### Summary of Embodiment

1. A vehicle control apparatus (for example, 1) according to the above-described embodiment is a vehicle control apparatus capable of switching driving control between automated driving and manual driving, comprising:

a detection unit (for example, 34b, 35) configured to detect an intervention operation by a driver during traveling by the automated driving; and

a control unit (for example, 22) configured to switch steering control of an electric power steering (for example, 41) from automated steering to manual steering when the intervention operation is detected by the detection unit,

wherein the control unit executes suppression control to suppress an occurrence of abrupt steering when the detection unit detects the intervention operation during a turn of a vehicle (for example, S34, S51).

According to this embodiment, when switching from the automated driving to the manual driving during the turn of the vehicle, it is possible to suppress an occurrence of abrupt steering due to the influence of the SAT or the like and reduce a sense of incongruity for the driver.

2. In the vehicle control apparatus (for example, 1) according to the above-described embodiment,

in the suppression control, a steering torque of the electric power steering is controlled to cope with a self-aligning torque generated upon switching from the automated steering to the manual steering (for example, S41).

According to this embodiment, even if the steering operation of the driver delays when switching from the automated driving to the manual driving during the turn of the vehicle, it is possible to suppress an occurrence of abrupt steering due to the influence of the SAT.

3. In the vehicle control apparatus (for example, 1) according to the above-described embodiment,

in the suppression control, the steering torque is controlled to cope with the self-aligning torque based on a steering speed (for example, S41).

According to this embodiment, it is possible to more reliably suppress an occurrence of abrupt steering based on the steering speed.

4. In the vehicle control apparatus (for example, 1) according to the above-described embodiment,

the control unit executes the suppression control when a steering torque of the electric power steering immediately before the switching from the automated steering to the manual steering is not less than a predetermined value (for example, S22, S33).

According to this embodiment, it is possible to prevent the suppression control from being unnecessarily executed.

5. In the vehicle control apparatus (for example, 1) according to the above-described embodiment,

in the suppression control, a control characteristic concerning control of the electric power steering is changed in a direction to suppress a steering speed (for example, S51).

According to this embodiment, it is possible to using the same steering control processing in common by changing the control characteristic.

6. In the vehicle control apparatus (for example, 1) according to the above-described embodiment,

the control unit ends the suppression control when a predetermined condition is satisfied after a start of execution of the suppression control (for example, S25, S33).

According to this embodiment, it is possible to prevent the suppression control from being unnecessarily executed.

7. In the vehicle control apparatus (for example, 1) according to the above-described embodiment,

the intervention operation is a braking operation of the vehicle.

According to this embodiment, when switching from the automated driving to the manual driving by the braking operation, it is possible to reduce a sense of incongruity for the driver concerning steering.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefits of Japanese Patent Application No. 2017-254278, filed Dec. 28, 2017, which is hereby incorporated by reference herein in its entirety.

What is claimed is:

1. A vehicle control apparatus capable of switching driving control between automated driving and manual driving, comprising:
a detection unit configured to detect an intervention operation by a driver during traveling by the automated driving; and
a control unit configured to switch steering control of an electric power steering from automated steering to manual steering when the intervention operation is detected by the detection unit,
wherein the control unit executes suppression control to suppress an occurrence of abrupt steering when the detection unit detects the intervention operation during a turn of a vehicle.

2. The apparatus according to claim 1, wherein in the suppression control, a steering torque of the electric power steering is controlled to cope with a self-aligning torque generated upon switching from the automated steering to the manual steering.

3. The apparatus according to claim 2, wherein in the suppression control, the steering torque is controlled to cope with the self-aligning torque based on a steering speed.

4. The apparatus according to claim 1, wherein the control unit executes the suppression control when a steering torque of the electric power steering immediately before the switching from the automated steering to the manual steering is not less than a predetermined value.

5. The apparatus according to claim 1, wherein in the suppression control, a control characteristic concerning control of the electric power steering is changed in a direction to suppress a steering speed.

6. The apparatus according to claim 1, wherein the control unit ends the suppression control when a predetermined condition is satisfied after a start of execution of the suppression control.

7. The apparatus according to claim 1, wherein the intervention operation is a braking operation of the vehicle.
